(19) United States
(12) Patent Application Publication
(10) Pub. No.: US 2006/0097172 A1
(43) Pub. Date: May 11, 2006

(54) Imaging apparatus, medium, and method using infrared rays with image discrimination

(75) Inventor: Gyutae Park, Gyeonggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/269,549

(22) Filed: Nov. 9, 2005

(30) Foreign Application Priority Data
Nov. 9, 2004 (KR) 10-2004-0090917

(51) Int. Cl. G01J 5/00

(52) U.S. Cl. 250/338.1

(57) ABSTRACT

An imaging apparatus, medium, and apparatus using infrared rays with image discrimination. The imaging apparatus may includes an image sensor optically together sensing a visible light component and an infrared component of an image, and an image processor to recognize an object component of the image. Accordingly, an infrared component cell can be far more easily implemented than conventionally. Also, an object component can be more accurately identified while being less affected by ambient illumination of the object component because an infrared component is used. Furthermore, both iris identification and color image acquisition can be achieved using a single camera by employing the image sensor, which senses the infrared component and the visible light component together. Thus, both the iris identification and the color image acquisition can be incorporated and executed by a single camera. Therefore, the imaging apparatus can be made compact.

### CROSS-REFERENCE TO RELATED APPLICATIONS

This application claims the benefit of Korean Patent Application No. 10-2004-0090917, filed on Nov. 09, 2004, in the Korean Intellectual Property Office, the disclosure of which is incorporated herein in its entirety by reference.

### BACKGROUND OF THE INVENTION

1. Field of the Invention

Embodiments of the present invention can relate to an image sensor included in commercial-use mobile terminals (e.g., cellular phones), electronic wallets that require user authentication, monitoring equipment for monitoring a figure, stereo vision systems, three-dimensional face recognition apparatuses, iris recognition apparatuses, vehicle sensors for sleepiness prevention, vehicle sensors for informing of distances between vehicles, vehicle sensors for warning of the existence of an obstacle/person in front of a vehicle, etc., and more particularly, to an imaging apparatus, medium, and method using infrared rays which can sense an infrared component as well as visible light components from a spectrum of a light, e.g., for identifying an image based on a result of the sensing.

2. Description of the Related Art

Conventional imaging methods have tried to improve the resolution power of an image. Such conventional imaging methods use a color filter array (CFA), an example of which is disclosed in U.S. Pat. No. 3,971,065, entitled “Color Imaging Array”. The main objective of this conventional method is to sense three visible light components, which are a red (R) component, a green (G) component, and a blue (B) component, from a spectrum of a light.

Since the infrared (IR) component of an image degrades the quality of the image, most conventional imaging methods, including the aforementioned method, have tried to obtain a clean and clear color image comparable to human eyesight of by removing the IR component as much as possible from the image.

Another conventional imaging method is disclosed in U.S. Pat. No. 6,292,212, entitled “Electronic Color Infrared Camera”. In this method, a general camera includes either an IR component removal filter or a yellow (Y) component transmission filter. When the Y component transmission filter is used, three components of an image, which may be R, G, and IR components, are sensed. On the other hand, when the IR component removal filter is used, three components of the image, which may be R, G, and B components, are sensed. However, in these methods, all of the R, G, B, and IR components cannot be sensed.

A conventional method of sensing an IR component, in contrast with the above-described conventional methods, is disclosed in U.S. Pat. No. 6,657,663, entitled “Pre-subtracting Architecture for Enabling Multiple Spectrum Image Sensing”. In this method, an IR filter, which transmits an IR component, is produced by overlapping an R filter, transmitting an R component, and a B filter, transmitting a B component. However, the overlapping of the two R and B filters to produce the IR filter increases the number of processes required to photograph an IR component.

In addition, the conventional methods of recognizing a face using visible rays have been discussed by W. Zhao, R. Chellappa, P. J. Phillips, and A. Rosenfeld in “Face Recognition—A Literature Survey”, ACM Computing Surveys, Vol. 35, No. 4, pp. 399-458 (December, 2003), who indicate that the performance of face recognition is very sensitive to illumination change.

A conventional method of recognizing the iris of the eye using infrared rays has further been discussed in U.S. Pat. No. 5,291,560, entitled “Biometric Personal Identification System Based on Iris Analysis”. To perform this conventional method, an extra camera is used for recognizing the iris of the eye in addition to the camera used for taking a corresponding photograph. In other words, here, two cameras are required to recognize the iris of the eye and take a photograph according to this conventional method. The use of two cameras leads to the enlargement of any corresponding imaging apparatus. Particularly, when mobile terminals, such as, cellular phones including a camera function, use such conventional iris recognition methods, the resulting enlarged size of the terminals becomes a serious problem.

### SUMMARY OF THE INVENTION

Embodiments of the present invention provide an imaging apparatus, medium, and method for using infrared rays which may sense at least one visible light component and an infrared component included in a spectrum of light.

Embodiments of the present invention also provide an imaging apparatus, medium, and method for using infrared rays which can better identify an object of interest from an image using a sensed infrared component in the image.

To achieve the above and/or other aspects and advantages, embodiments of the present invention include an imaging device for converting an optically sensed measurement into an electrical signal, the imaging device including a patterned array with repeated optically sensing unit cells, wherein the unit cells include at least one color component cell optically sensing a respective color measurement, including at least a respective visible light component, and an infrared component cell optically sensing an infrared measurement, including at least a respective infrared component.

The imaging device may further include a component separator separating a color component from the infrared measurement by performing an arithmetic operation with one of the respective color measurements and the infrared measurement sensed by the patterned array, wherein the at least one color component cell also senses an infrared component, and the infrared component cell also senses a visible light component.

To achieve the above and/or other aspects and advantages, embodiments of the present invention include an imaging apparatus, including an imaging device according to an embodiment of the present invention, and an image processor for recognizing an object component in the electrical signal generated by the imaging device.

To achieve the above and/or other aspects and advantages, embodiments of the present invention include an imaging apparatus using infrared rays, including an image sensor optically sensing both a visible light component and an infrared component included in a light spectrum in an optically sensed measurement and converting the sensed visible light component and infrared component into an electrical signal, and an image processor to recognize an object component in the electrical signal.

The image sensor may include a patterned array including repeated unit cells that collect the optically sensed measurement, wherein the unit cells may include at least one color component cell optically sensing a respective color measurement, including at least a respective visible light, and an infrared component cell optically sensing an infrared measurement, including at least a respective infrared component.

The infrared component cell may also senses a color component. In addition, the image sensor may further include a component separator to separate a color component from the infrared measurement by performing an arithmetic operation with one of the respective color measurements and the infrared measurement, wherein the at least one color component cell also senses an infrared component.

The infrared measurement may only sense an infrared component. Further, the image sensor may further include a component separator to derive a color component from an arithmetic operation with one of the respective color measurements and the infrared measurement, wherein the at least one color component cell also senses an infrared component.

The image processor may include an image control unit to receive the electrical signal, to image-process the electrical signal, and to output a result of the image-processing as an image signal, an object discriminating unit to extract an object component, which is a target of interest in the image signal, from the image signal and to discriminate the extracted object component, and a main control unit to control the image control unit, the image sensor, and/or the object discriminating unit.

The object discrimination unit may execute authentication to determine whether the discriminated object component is an allowed object component.

In addition, the image processor may further include a user manipulation unit to generate a user signal based on a manipulation of a user and to output the user signal to the main control unit, a display unit to display a result of the discrimination by the object discriminating unit to the user, and a light emitting unit to emit at least one of a visible light and an infrared ray to an image area, corresponding to the image, under the control of the main control unit, wherein the main control unit controls the image control unit, the image sensor, the object discriminating unit, and the light emitting unit in response to the user signal.

The image control unit may include a control signal generation unit to output a first control signal, received from the main control unit, to the image sensor and second and third control signals received from the main control unit, a white balancing processing unit to execute white balancing on the visible light component included in the electrical signal in response to the second control signal and outputting a result of the white balancing, and a component selection unit to select, in response to the third control signal, one of the infrared component included in the electrical signal and the result of the white balancing received from the white balancing processing unit and to output a result of the selection as the image signal wherein the image sensor senses the image in response to the first control signal.

The object discrimination unit may include an object component extraction unit to extract the object component from the image signal, a recognition unit to calculate a score of the extracted object component using templates of a pre-allowed object component, and an authentication unit to compare the score with a predetermined critical value and authenticating whether the extracted object component matches the pre-allowed object component.

The object discrimination unit may further include a database storing the templates of the pre-allowed object components, and a registration unit to register the templates of the pre-allowed object component in the database.

The object component may at least be one of a face and an iris.

In addition, the object component extraction unit may include a storage unit to store the image signal and to output the infrared component included in the stored image signal to the recognition unit, a face extraction unit to extract a face from the stored image signal and to output the extracted face to the recognition unit, and an eye extraction unit to extract an eye from the extracted face and to output the extracted eye to the recognition unit.

Further, the recognition unit may include a face normalization unit to normalize a face image using the extracted face and the infrared component, a face template extraction unit to extract a template of the face from the normalized face image, a face score calculation unit to calculate a score of the extracted template for the face based on a result of a comparison of the extracted face template with the templates of the pre-allowed object component, an iris separation unit to separate an iris image using the extracted eye and the infrared component, an iris normalization unit to normalize the separated iris image, an iris template extraction unit to extract a template of the iris from the normalized iris image, and an iris score calculation unit to calculate a score of the extracted template of the iris based on a result of the a comparison of the extracted template of the iris with the templates of the pre-allowed object component.

To achieve the above and/or other aspects and advantages, embodiments of the present invention include an discriminating method, including determining whether a user is to be authenticated, optically sensing both a visible light component and an infrared component included in a light spectrum of an image and converting the sensed visible light component and infrared component into an electrical signal, based on the determination of whether the user is to be authenticated, determining whether an object component, which is a target of interest in the image, is extracted from the electrical signal, determining whether the extracted object component matches a pre-registered allowed object component based on the determination of whether the object component is extracted from the electrical signal, determining that the extracted object component has an appropriate identity, based on an appropriate identity result for the determination of whether the extracted object component matches the pre-registered allowed object component, determining that the extracted object component does not have the appropriate identity, based on not obtaining an appropriate identity result for the determination of whether the extracted object component matches the pre-registered allowed object component or based on the determination that the object component is not extracted from the electrical signal, and outputting an indication of whether the extracted object component is the appropriate identity.

The determining of whether the extracted object component matches the pre-registered allowed object component may include calculating a score of the extracted object component by comparing a template of the extracted object component with a pre-stored template of the object component, and determining whether the score is greater than a critical value, wherein when the score is determined to be greater than the critical value the object component is considered to match the pre-registered allowed object component.

To achieve the above and/or other aspects and advantages, embodiments of the present invention include at least one medium including computer readable code to implement embodiments of the present invention.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates an imaging apparatus, according to an embodiment of the present invention;

FIG. 2 illustrates a patterned array;

FIGS. 3A through 3F illustrate example configurations of the unit cells, such as those shown in FIG. 2, according to embodiments of the present invention;

FIGS. 4A and 4B illustrate example configurations of unit cells, such as those shown in FIG. 2, according to further embodiments of the present invention;

FIG. 5 illustrates an imaging apparatus using infrared rays, according to another embodiment of the present invention;

FIG. 6 illustrates an image processor, such as that shown in FIG. 5, according to an embodiment of the present invention;

FIG. 7 illustrates an image control unit, such as that shown in FIG. 6, according to an embodiment of the present invention;

FIG. 8 illustrates an object discrimination unit, such as that shown in FIG. 6, according to an embodiment of the present invention;

FIG. 9 illustrates an object component extraction unit, such as that shown in FIG. 8, according to an embodiment of the present invention;

FIG. 10 illustrates a recognition unit, such as that shown in FIG. 8, according to an embodiment of the present invention;

FIG. 11 is a flowchart illustrating an object discriminating method, according to an embodiment of the present invention; and

FIG. 12 is a flowchart illustrating an operation, such as operation 186 shown in FIG. 11, according to an embodiment of the present invention.

### DETAILED DESCRIPTION OF THE PREFERRED EMBODIMENTS

Reference will now be made in detail to embodiments of the present invention, examples of which are illustrated in the accompanying drawings, wherein like reference numerals refer to the like elements throughout. Embodiments are described below to explain the present invention by referring to the figures.

An imaging apparatus according to an embodiment of the present invention, for converting an optically sensed image into an electrical signal and outputting the electrical signal, will now be described below.

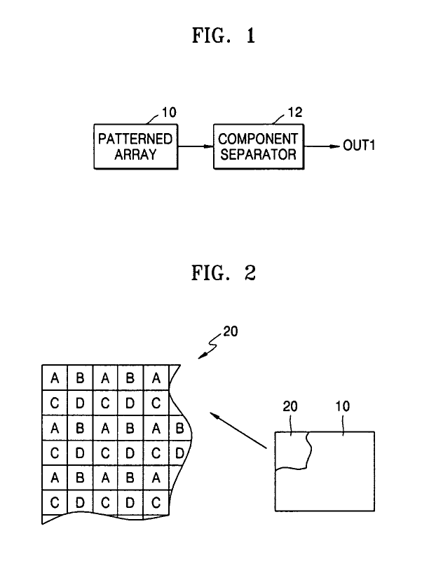

FIG. 1 illustrates an imaging device, according to an embodiment of the present invention, for converting an optically sensed light into an electrical signal and outputting the electrical signal. The imaging device may include a patterned array 10 and a component separator 12.

The patterned array 10 optically senses an image and has a pattern in which unit cells are repeated. The unit cells include at least one color component cell and an infrared component cell. A color component cell senses a corresponding visible light component in a spectrum of light. The infrared component cell may sense only an infrared component in the light spectrum. For example, the unit cells may have a plurality of color component cells which respectively sense a red (R) component, a green (G) component, and a blue (B) component which are visible light components. The infrared component cell may be implemented as a single cell through which the infrared component is sensed, in contrast with the aforementioned conventional method disclosed in U.S. Pat. No. 6,657,663, in which an infrared component cell is produced by overlapping two color component cells.

FIG. 2 illustrates the patterned array 10 and a magnified portion 20 of the patterned array 10, according to an embodiment of the present invention. Referring to FIG. 2, the patterned array 10 has the pattern in which unit cells are repeated. The unit cells can be classified into 4 cells A, B, C, and D.

In an embodiment of the present invention, the four cells A, B, C, and D may sense an R component, a G component, and a B component, which are visible light components, and an infrared (IR) component included in the spectrum of light. The unit cells may be formed through various tiling arrangements other than the tiling as shown in FIG. 2.

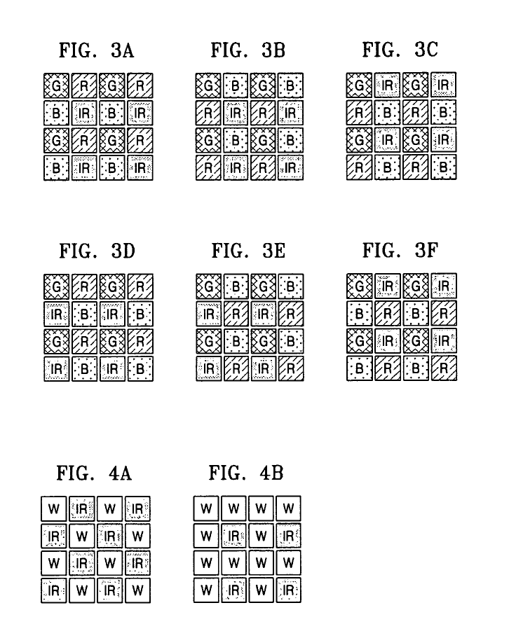

FIGS. 3A through 3F illustrate brief examples of tilings in which unit cells shown in FIG. 2 can be arranged, according to further embodiments of the present invention. Here, R denotes a cell that senses an R component, G denotes a cell that senses a G component, B denotes a cell that senses a B component, and IR denotes a cell that senses an IR component.

When the unit cells A, B, C, and D of FIG. 2 sense R, G, B, and IR components, the patterned array 10 may have any one of the 6 types of tiling shown in FIGS. 3A through 3F, for example.

FIGS. 4A and 4B illustrate further examples of tilings in which unit cells shown in FIG. 2 can be arranged, according to still another embodiment of the present invention. Here, IR denotes a cell that senses an IR component, and W denotes a cell that senses a monochrome (W) component, which is one of the visible light components.

In an embodiment of the present invention, as shown in FIG. 4A, two of the four unit cells A, B, C, and D may sense the IR component included in the spectrum of light, and the other two unit cells may sense the W component among the visible light components. Alternatively, as shown in FIG. 4B, one of the four unit cells A, B, C, and D may sense the IR component included in the spectrum of an image, and the other three unit cells may sense the W component among the visible light components.

In the above-described embodiments, the imaging device of FIG. 1 may not include the component separator 12 because each of the unit cells senses only one component.

However, in an embodiment of the present invention, the color component cell included in the patterned array 10 may also sense an IR component, and the IR component cell may also sense at least one visible light component. In this case, the imaging apparatus of FIG. 1 may further include the component separator 12 to separate the visible light components from the IR component by performing an arithmetic operation on the components sensed by the patterned array 10. The separated visible light components and the IR component can be output via an output port OUT1.

For example, the unit cell A of the patterned array 10 may sense the R component among visible light components and the IR component included in the spectrum of light, the unit cell B thereof may sense the G component among visible light components and the IR component included in the spectrum of light, the unit cell C thereof may sense the B component among visible light components and the IR component included in the spectrum of light, and the unit cell D thereof may sense all of the R, G, B, and IR components. In this case, the component separator 12 may be used to separate the visible light components R, G, and B from the IR component through an arithmetic operation, such as expressed below in Equation 1:

$$\begin{matrix}IR = \frac{TA + TB + TC + TD}{2} \\ R = TA - IR \\ G = TB - IR \\ B = TC - IR\end{matrix} \qquad ( 1 )$$

Here, TA denotes the R and IR components sensed by the unit cell A, TB denotes the G and IR components sensed by the unit cell B, TC denotes the B and IR components sensed by the unit cell C, and TD denotes the R, G, B and IR components sensed by the unit cell D.

Accordingly, the imaging device of FIG. 2 may serve as an image sensor (not shown), such as a conventional charged coupled device (CCD) type image sensor, a complementary metal oxide semiconductor (CMOS) type image sensor, or an image sensor using infrared rays. That is, the imaging device of FIG. 2 may also be used as a substitute for the image sensor.

An imaging apparatus using infrared rays for discriminating light will now be described in greater detail.

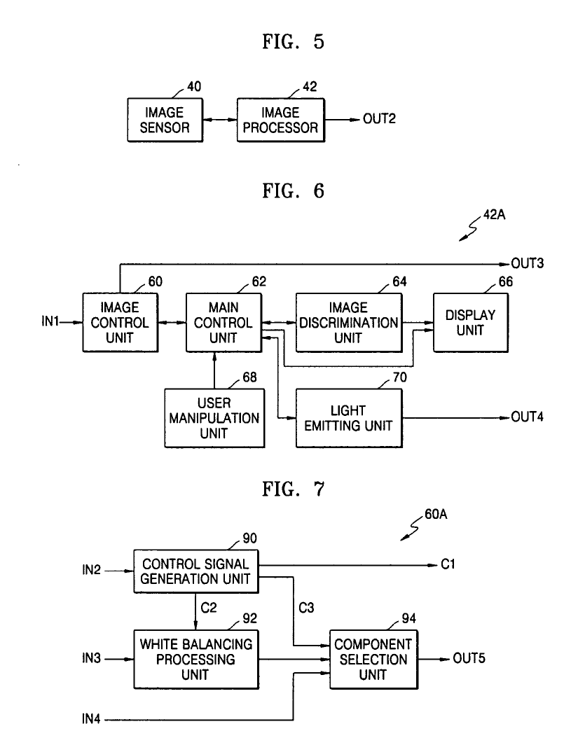

FIG. 5 illustrates an imaging apparatus using infrared rays, according to another embodiment of the present invention. The imaging apparatus may include an image sensor 40 and an image processor 42.

The image sensor 40 may optically sense visible light components and an IR component included in the spectrum of a light, convert the optically sensed light into an electrical signal, and output the electrical signal to the image processor 42.

Here, the imaging device of FIG. 1 may be used as the image sensor 40, for example. Thus, the image sensor 40 may be the patterned array 10 or include the patterned array 10 and the component separator 12, for example. In other words, the imaging device of FIG. 1 and the further above-described embodiments of the unit cells of FIG. 2 may also be implemented in the image sensor 40 of FIG. 5.

According to yet another embodiment of the present invention, the color component unit cell of the patterned array 10, included in the image sensor 40, may sense the IR component as well as the visible light components, and the IR component cell may sense only the IR component. In this case, the image sensor 40 may further include the component separator 12 of FIG. 1. The component separator 12 may perform a corresponding arithmetic operation, for example, on the components sensed by the patterned array 10 to separate the visible light components from the IR component and output the separated visible light components and the IR component via the output port OUT1.

For example, the unit cell A may sense the R component among the visible light components and the IR component, the unit cell B may sense the G component among the visible light components and the IR component, the unit cell C may sense the B component among the visible light components and the IR component, and the unit cell D may sense only the IR component. In this case, the component separator 12 may separate the visible light components R, G, and B from the IR component through the following arithmetic operation expressed in Equation 2:
R=TA−TD
C=TB−TD
B=TC−TD
IR=TD

Here, TA denotes the R and IR components sensed by the unit cell A, TB denotes the G and IR components sensed by the unit cell B, TC denotes the B and IR components sensed by the unit cell C, and TD denotes the IR component sensed by the unit cell D.

The image processor 42 of FIG. 5 may recognize an object component of interest from an image based on the electrical signal received from the image sensor 40 and may output a result of the recognition via an output port OUT2.

As described above, the component separator 12 of FIG. 1 may be included in the image sensor 40. However, the component separator 12 may alternately be included in the image processor 42 and not in the image sensor 40.

The following description will rely on the component separator 12 being included in the image sensor 40 for expediency of explanation. However, the present invention is not limited to this arrangement.

FIG. 6 illustrates an image processor 42A, which is another embodiment for the image processor 42 of FIG. 5. The image processor 42A may include an image control unit 60, a main control unit 62, an object discrimination unit 64, a display unit 66, a user manipulation unit 68, and a light emitting unit 70, for example.

According to an embodiment of the present invention, the image processor 42A may alternately include only the image control unit 60, the main control unit 62, and the object discrimination unit 64.

The image control unit 60 may receive the electrical signal from the image sensor 40, via the input port IN1, perform image processing on the electrical signal, and output a result of the image processing as an image signal to the main control unit 62.

FIG. 7 illustrates an image control unit 60A, which is another embodiment for the image control unit 60 shown in FIG. 6. The image control unit 60A may include a control signal generation unit 90, a white balancing processing unit 92, and a component selection unit 94.

The control signal generation unit 90 may receive a first control signal C1 from the main control unit 62, via an input port IN2, and output the same to the image sensor 40. Referring to FIG. 6, the image control unit 60 may output the first control signal C1 to the image sensor 40 via an output port OUT3. The image sensor 40 may sense an image in response to the first control signal C1, received from the control signal generation unit 90 of the image control unit 60A. In other words, when it is recognized through the first control signal C1 that image sensing is requested, the image sensor 40 may sense light. The control signal generation unit 90 may receive second and third control signals C2 and C3 from the main control unit 62 and further output the second control signal C2 to the white balancing processing unit 92 and the third control signal C3 to the component selection unit 94.

The white balancing processing unit 92 may receive visible light components, included in the electrical signal from the image sensor 40 via an input port IN3, and may perform white balancing on the visible light components in response to the second control signal C2, received from the control signal generation unit 90, and output a result of the white balancing to the component selection unit 94. At this time, the white balancing processing unit 92 may execute white balancing and/or the degree to which white balancing should be/is executed, in response to the second control signal C2.

The component selection unit 94 may receive an IR component, included in the electrical signal from the image sensor 40 via an input port IN4, and the result of the white balancing from the white balancing processing unit 92. Then, the component selection unit 94 may select either the result of the white balancing or the IR component in response to the third control signal C3, received from the control signal generation unit 90, and may output the result of the selection as an image signal to the main control unit 62 via an output port OUT5.

Referring back to FIG. 6, the object discriminating unit 64 may receive the image signal from the image control unit 60 via the main control unit 62, and may extract an object component, i.e., a target of interest, from the image signal, and may recognize the extracted object component. The object discrimination unit 64 may further authenticate whether the recognized object component is an allowed object component, for example.

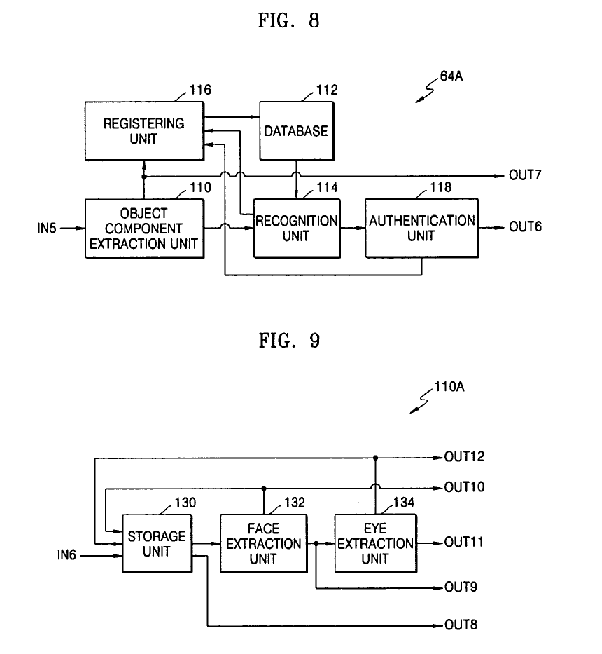

FIG. 8 illustrates an object discrimination unit 64A, which is an embodiment for the object discrimination unit 64 of FIG. 6. The object discrimination unit 64A may include an object component extraction unit 110, a database 112, a recognition unit 114, a registering unit 116, and an authentication unit 118, for example.

The object component extraction unit 110 may extract an object component from the image signal received from the image control unit 60, via the main control unit 62 and via the input port IN5, and may output the extracted object component to the recognition unit 114. The object component extraction unit 110 may output a signal indicating extraction or non-extraction of the object component to the registering unit 116 and to the main control unit 62 via an output port OUT7.

The recognition unit 114 may calculate a score of the object component extracted by the object component extraction unit 110, e.g., using templates stored in the database 112, and output the score to the authentication unit 118. The object component extracted by the image processor 42 of FIG. 5 may be at least one of a face and an iris of a person, for example. When the object component is a face, an operation of the recognition unit 14 may be implemented according to the discussed operation in U.S. patent application Ser. No. 10/685,002, entitled “Method and Apparatus for Extracting Feature Vector Used for Face Recognition and Retrieval”, filed on Oct. 15, 2003, for example.

The database 112 may pre-store templates of allowed object components.

To facilitate understanding of the object component extraction unit 110 and the recognition unit 114 of FIG. 8, the following discussion will be based on the object component being either a face or an iris. However, embodiments of the present invention are not limited by these object component examples.

FIG. 9 illustrates an object component extraction unit 110A, which is another embodiment for the object component extraction unit 110 of FIG. 8. The object component extraction unit 110A may include a storage unit 130, a face extraction unit 132, and an eye extraction unit 134, for example.

The storage unit 130 may store the image signal received from the image control unit 60 via the main control unit 62 and an input port IN6. Here, the storage unit 130 may serve as a buffer, for example. The storage unit 130 may output the infrared component of the stored image signal to the recognition unit 114 via an output port OUT8.

The face extraction unit 132 may extract a face from the image signal, e.g., for a current frame stored in the storage unit 130, and output the extracted face to the recognition unit 114 via an output port OUT9. At this time, the face extraction unit 132 may also output a signal indicating whether a face has been extracted from the image signal for the current frame to the registering unit 116, via an output port OUT10, and to the storage unit 130, for example. The signal indicating whether a face has been extracted from the image signal may correspond to the signal indicating extraction or non-extraction of the object component. When recognizing from the signal indicating extraction or non-extraction of the face that the face has not been extracted, the storage unit 130 may then output an image signal for a next frame to the face extraction unit 132.

The eye extraction unit 134 may extract an eye from the face extracted by the face extraction unit 132 and output the extracted eye to the recognition unit 114 via an output port OUT11. At this time, the eye extraction unit 134 may also output a signal indicating whether the eye has been extracted from the face to the registering unit 116, via an output port OUT12 and to the storage unit 130, for example. The signal indicating whether the eye has been extracted from the face may correspond to the signal indicating extraction or non-extraction of the object component. When recognizing from the signal indicating extraction or non-extraction of the eye that the eye has not been extracted, the storage unit 130 may then output the image signal for the next frame to the face extraction unit 132.

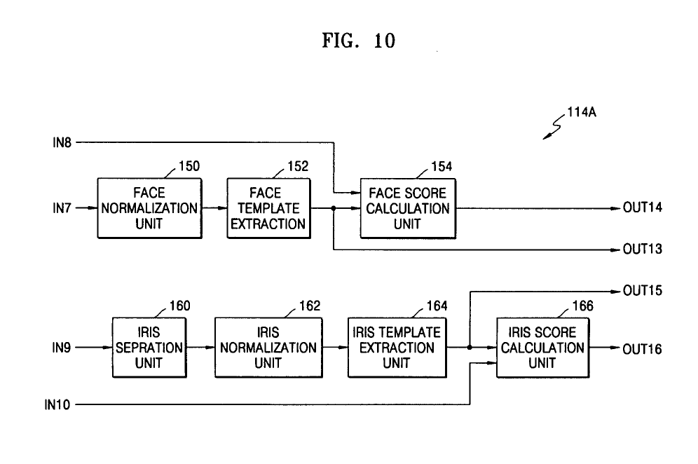

FIG. 10 illustrates a recognition unit 114A, which is another embodiment of the present invention for the recognition unit 114 of FIG. 8. The recognition unit 114A may include a face normalization unit 150, a face template extraction unit 152, a face score calculation unit 154, an iris separation unit 160, an iris normalization unit 162, an iris template extraction unit 164, and an iris score calculation unit 166, for example.

The face normalization unit 150 may normalize a face image using the face extracted by the face extraction unit 132 and received via an input port IN7 and the IR component received from the storage unit 130, for example, via an input port IN7 and output the face image to the face template extraction unit 152. For example, the face normalization unit 150 may produce the normalized face image using a process, such as, a histogram equalization of the face using the infrared component. The face template extraction unit 152 may extract a face template from the normalized face image received from the face normalization unit 150, for example, and output the normalized face template to the face score calculation unit 154 and also to the registering unit 116 via an output port OUT13. The face score calculation unit 154 may compare the face template extracted by the face template extraction unit 152 with a template received from the database 112, for example, via an input port IN8, calculate a score of the extracted face template based on a result of the comparison, and output the score to the authentication unit 118 via an output port OUT14.

The iris separation unit 160 may separate an iris image from an eye image using the extracted eye received from the eye extraction unit 134 via an input port IN9 and the infrared component received from the storage unit 130, for example, via the input port IN9 and output the separated iris image to the iris normalization unit 162. The iris normalization unit 162 may normalize the separated iris image received from the iris separation unit 160 and output the normalized iris image to the iris template extraction unit 164. For example, the iris normalization unit 162 may normalize the iris image by enhancing an edge of the iris and equalizing a histogram of the iris. The iris template extraction unit 164 may extract an iris template from the normalized iris image received from the iris normalization unit 162, for example, and output the extracted iris template to the iris score calculation unit 166 and also to the registering unit 116 via an output port OUT15. The iris score calculation unit 166 may compare the iris template extracted by the iris template extraction unit 164 with a template received from the database 112, for example, via an input port IN10, calculate a score of the extracted iris template based on a result of the comparison, and output the calculated score to the authentication unit 118 via an output port OUT16.

Referring back to FIG. 8, the registering unit 116 may receive a template of the object component, extracted in an initial state of an imaging apparatus by the object component extraction unit 110, from the recognition unit 114 and register the template of the object component in the database 112, for example.

According to an embodiment of the present invention, when recognizing, from the signal indicating the extraction or non-extraction of the object component, which may be received from the object component extraction unit 110, that the object component has been extracted, the registering unit 116 may register extracted templates received from the recognition unit 114 in the database 112, for example.

According to another embodiment of the present invention, the registering unit 116 may register only effective templates for object components, among the extracted templates for object components, in the database 112. To achieve this, the authentication unit 118, which may be in an initial state, may compare the score received from the recognition unit 114 with a critical value, authenticate whether the extracted template for the object component is effective in response to a result of the comparison, and output a result of the authentication to the registering unit 116. When recognizing from the result of the authentication received from the authentication unit 118 that the template extracted by the recognition unit 114 is effective, the registering unit 116 may determines the extracted template to be an effective template for the object component.

When the authentication unit 118 is in a normal state, it may compare the score received from the recognition unit 114 with the critical value, authenticate whether the extracted object component is previously allowed, in response to a result of the comparison, and output a result of the authentication to the main control unit 62 and the display unit 66 via an output port OUT6.

As described above, the main control unit 62 of FIG. 6 may control the image sensor 40, using the first control signal C1, for example, with the image control unit 60. The main control unit 62 may control the image control unit 60, e.g., using the second and third control signals C2 and C3. The main control unit 62 may also control an operation of the object discrimination unit 64.

According to another embodiment of the present invention, the image processor 42A of FIG. 6 may further include the display unit 66, the user manipulation unit 68, and the light emitting unit 70, for example.

Referring back to FIG. 6, the display unit 66 may receive the image signal from the main control unit 62 and display an image corresponding to the image signal to a user. The display unit 66 may also display to the user a result of the image discrimination by the object discrimination unit 64. The user manipulation unit 68 may generate a user signal, e.g., through a user's manipulation, and output the user signal to the main control unit 62. To do this, the user manipulation unit 68 may be a key button (not shown), etc., noting that alternative manipulation units are available. The main control unit 62 may control the image control unit 60, the image sensor 40, the object discrimination unit 64, and the light emitting unit 70, for example, in response to the user signal received from the user manipulation unit 68.

According to an embodiment of the present invention, the main control unit 62 may generate the first, second, and third control signals C1, C2, and C3, in response to the user signal received from the user manipulation unit 68.

According to another embodiment of the present invention, the first, second, and third control signals C1, C2, and C3, generated by the main control unit 62, may be predetermined control signals.

Under the control of the main control unit 62, the light emitting unit 70 may emit at least one of an infrared light and visible light, via an output port OUT4. If the object component discriminated from the image, by the image processor 42 of FIG. 5, is an iris, the light emitting unit 70 may emit infrared light to toward the iris.

If an embodiment of the present invention is applied to a case where a camera is connected to a computer, the image sensor 40 of FIG. 5 and the image control unit 60 of FIG. 6 may be included in the camera, and the main control unit 62, the object discrimination unit 64, the display unit 66, the user manipulation unit 68, and the light emitting unit 70 may be included with the computer. If an embodiment of the present invention is applied to a standalone device, e.g., where a camera is integrated with computer capabilities, the image sensor 40 and the image processor 42 or 42A may all, for example, be included in the standalone device.

Hereinafter, an object discriminating method using infrared light, according to an embodiment of present invention, where an image is sensed and an image component is discriminated using the sensed image, will be described in greater detail.

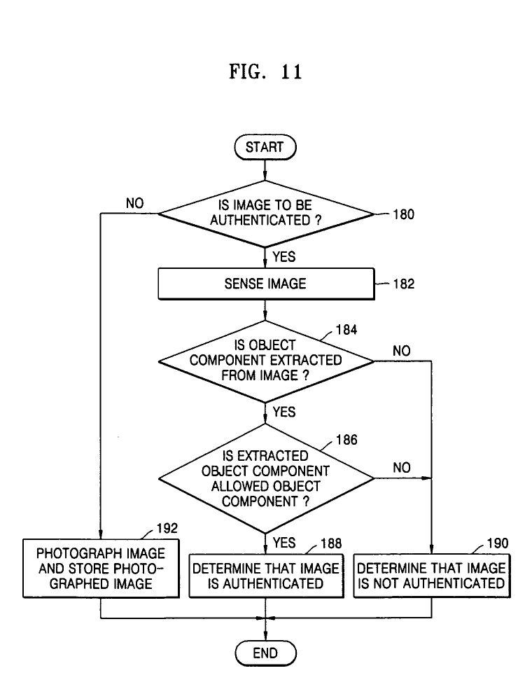

FIG. 11 is a flowchart illustrating an object discriminating method, according to an embodiment of the present invention. This method includes operations 180 and 182 of sensing an image when an object in the image is to be authenticated, operations 184 through 190 of checking if an extracted object component is allowed, and photographing operation 192 to obtain the photographed image.

To facilitate an understanding of the following embodiments of present invention, it is assumed, only herein, that the object discriminating method of FIG. 11 is performed when the imaging apparatus of FIG. 5 is in a normal state, and that templates of allowed object components are pre-registered in the database 112, for example, when the imaging apparatus of FIG. 5 is in an initial state, noting that alternative embodiments are equally available.

In operation 180, whether an object is to be authenticated is determined. The imaging apparatus of FIG. 5 may be used to authenticate an identity of the object or to sense the object. If it is determined that the object is to be authenticated, a visible light component and an infrared component may be optically sensed from a spectrum of light, and the sensed image may be converted into an electrical signal, in operation 182. If an object component is an iris, the light emitting unit 70 of FIG. 6, for example, may emit the infrared component to an object under the control of the main control unit 62, and the main control unit 62 may check if a desired image has been sensed by the image sensing unit 40 and stop light emission by the light emitting unit 70 upon recognizing that the desired has been sensed, in operation 182.

To facilitate an understanding of operations 180 and 182 of FIG. 11, the user manipulation unit 68 may be manipulated by a user who wants to perform an authentication operation or a user who wants to sense an image to generate a user signal and output the user signal to the main control unit 62. In response to the user signal, the main control unit 62 outputs the first control signal C1 to the image sensor 40 via the image control unit 60. Hence, the image sensor 40 may perform operation 182 in response to the first control signal C1, which is received from the main control unit 62 via the image control unit 60.

After operation 182, the image processor 42 may determine, based on the electrical signal received from the image sensor 40, whether an object component, i.e., a target of interest, is extracted from an image, in operation 184. To do this, the main control unit 62 may receive a signal indicating extraction or non-extraction of an object component from the object discrimination unit 64, for example, from the object component extraction unit 110 of FIG. 8, and perform operation 184 using the signal indicating extraction or non-extraction of an object component. Alternatively, in receiving the object component extracted by the object component extraction unit 110, the recognition unit 114 may determine that the object component has been extracted.

If an object component is a face and an iris, after operation 182, it may be determined, from the electrical signal, whether a face has been extracted, and if it is determined that the face has been extracted, another determination as to whether an eye has been extracted from the extracted face is made, in operation 184. If it is determined that the object component has been extracted from the image, the image processor 42 may determine whether the extracted object component is a pre-registered allowed object component, in operation 186.

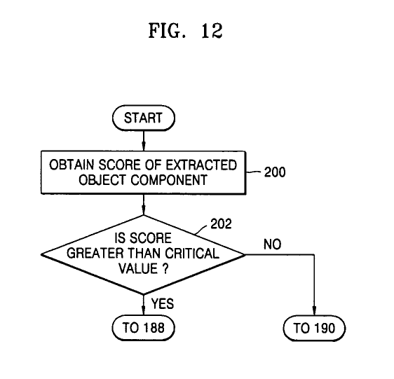

FIG. 12 is a flowchart illustrating an operation, such as operation 186 shown in FIG. 11, according to an embodiment of the present invention. Operation 186 may include operation 200 of obtaining a score of the extracted object component and operation 202 of comparing the score with a critical value.

The recognition unit 114 of FIG. 8 may check if an object component has been extracted by the object component extraction unit 110. When it is recognized that the object component has been extracted by the object component extraction unit 110, and received therefrom, the recognition unit 114 may extract a template for the extracted object component, compare the extracted template with a pre-stored template for an object component, and obtain a score of the extracted object component, for example, in operation 200.

After operation 200, the authentication unit 118 may determine, using the score calculated by the recognition unit 114, whether the extracted object component is an allowed object component. In other words, the authentication unit 118 may determine whether the score is greater than the critical value, for example, in operation 202. When the score is greater than the critical value, the extracted object component may be a pre-registered allowed object component.

If the object component is a face and an iris, for example, the authentication unit 118 may simultaneously perform a comparison of the score of the iris with a critical value for the iris, and a comparison of the score of the face with a critical value for the face, in operation 202. Alternatively, the authentication unit 118 may perform the comparison of the score of the iris with the critical value for the iris prior to the comparison of the score of the face with the critical value for the face. Alternatively, the authentication unit 118 may perform the comparison of the score of the iris with the critical value for the iris after the comparison of the score of the face with the critical value for the face, noting that alternative embodiments are equally available.

Referring back to FIG. 11, if the extracted object component is determined to be an allowed object component, the extracted object component may be determined to have appropriate identity, in operation 188. On the other hand, if the extracted object component is determined to not be allowed or that no object components are extracted, the extracted object component may be determined to not have the appropriate identity, in operation 190. Operations 188 and 190 may be performed by the main control unit 62 of FIG. 6, for example. Here, the main control unit 62 may receive a result of the authentication from the authentication unit 118, via the output port OUT6, and perform operation 188 when recognizing from the result of the authentication that the extracted object component is an allowed object component. On the other hand, when recognizing from the result of the authentication that the extracted object component is not an allowed object component, the main control unit 62 may perform operation 190. Also, when recognizing from the signal indicating extraction or non-extraction of an object component, received from the object component extraction unit 110, that no object components are extracted, the main control unit 62 may further perform operation 190.

If it is determined in operation 180 that an image is only to be sensed, for example, instead of being authenticated, the image may be sensed and stored, in operation 192. To perform operation 192, the image sensor 40 may sense the image, and the image control unit 60 of the image processor 42A may produce an image signal based on a result of the sensing and output the image signal to the main control unit 62. The main control unit 62 may output the image signal to the display unit 66. The display unit 66 may display an image corresponding to the image signal received from the main control unit 62.

As described above, embodiments of an imaging apparatus, medium, and method using infrared rays, such as that of FIG. 5, and embodiments thereof, and that of the image discriminating method of FIG. 11, are applicable to recognize and/or authenticate an object component, such as, a face and/or an iris of a human. This imaging is also applicable to color and infrared cameras that sense a color image and an infrared image together.

In contrast with a conventional imaging apparatus, including separate cameras for recognizing an iris and for sensing a color image, an imaging apparatus according to an embodiment of the present invention can recognize an object component and obtain a color image using a single camera. Hence, an imaging apparatus according to embodiments of the present invention may be widely applied to mobile terminals (e.g., cellular phones), criminal discriminating apparatuses which compare faces of suspects with personal items of criminals, airline passenger discriminating apparatuses that compare faces of airline passengers with pictures on passports of the passengers, entrance terminals based on biometric authentication, etc., for example. In this case, the imaging apparatus according to embodiments of present invention may authenticate users by recognizing at least one of their irises and their face, which are taken as objects to be extracted from images. Furthermore, the imaging apparatus, according to embodiments of the present invention, may also be used to determine, using an infrared component, whether an object extracted from an image is an image of a picture or a live image.

When an infrared lighting and a sensor recognize a person or an animal using an image, the imaging apparatus, using infrared rays and an object discrimination method thereof, may be used to implement a recognition system that is robust to surrounding illumination.

Further, as described above, according to embodiments of the present invention, an infrared component cell can be far more easily implemented than in the conventional art. In a conventional method of discriminating an object component of an image, for example, a face, without using an infrared component, discrimination is greatly affected by an ambient illumination around the face. However, according to embodiments of the present invention, an object component can be more accurately identified while being less affected by the ambient illumination of an object, such as, the face, because an infrared component of an image sensed by an implemented infrared filter is used. Furthermore, in contrast with the conventional art where an extra iris recognition camera is required to recognize an iris, in addition to an image sensing camera, embodiments of the present invention can perform both iris identification and color image acquisition using a single camera by employing the image sensor 40, sensing an infrared component and a visible light component together. In other words, the two operations, which are the iris identification and the color image acquisition, can be incorporated and executed by a single camera. Therefore, the imaging apparatus according to embodiments of the present invention can be made compact.

In addition to the above described embodiments, embodiments (and/or aspects of embodiments) of the present invention can also be implemented through computer readable code/instructions in/on a medium, e.g., a computer readable medium. The medium can correspond to any medium/media permitting the storing and/or transmission of the computer readable code.

The computer readable code can be recorded/transferred on a medium in a variety of ways, with examples of the medium including magnetic storage media (e.g., ROM, floppy disks, hard disks, etc.), optical recording media (e.g., CD-ROMs, or DVDs), and storage/transmission media such as carrier waves, as well as through the Internet, for example. The media may also be a distributed network, so that the computer readable code is stored/transferred and executed in a distributed fashion.

Although a few embodiments of the present invention have been shown and described, it would be appreciated by those skilled in the art that changes may be made in these embodiments without departing from the principles and sprit of the invention, the scope of which is defined in the claims and their equivalents.

What is claimed is:

1. An imaging device for converting an optically sensed measurement into an electrical signal, the imaging device including a patterned array with repeated optically sensing unit cells, wherein the unit cells comprise:
at least one color component cell optically sensing a respective color measurement, including at least a respective visible light component; and
an infrared component cell optically sensing an infrared measurement, including at least a respective infrared component.

2. The imaging device of claim 1, further comprising a component separator separating a color component from the infrared measurement by performing an arithmetic operation with one of the respective color measurements and the infrared measurement sensed by the patterned array,
wherein the at least one color component cell also senses an infrared component, and the infrared component cell also senses a visible light component.

3. An imaging apparatus, comprising:
the imaging device of claim 1; and
an image processor for recognizing an object component in the electrical signal generated by the imaging device.

4. An imaging apparatus using infrared rays, comprising:
an image sensor optically sensing both a visible light component and an infrared component included in a light spectrum in an optically sensed measurement and converting the sensed visible light component and infrared component into an electrical signal; and
an image processor to recognize an object component in the electrical signal.

5. The imaging apparatus of claim 4, wherein the image sensor comprises a patterned array including repeated unit cells that collect the optically sensed measurement, wherein the unit cells comprise:
at least one color component cell optically sensing a respective color measurement, including at least a respective visible light; and
an infrared component cell optically sensing an infrared measurement, including at least a respective infrared component.

6. The imaging apparatus of claim 5, wherein the infrared component cell also senses a color component.

7. The imaging apparatus of claim 6, wherein the image sensor further comprises a component separator to separate a color component from the infrared measurement by performing an arithmetic operation with one of the respective color measurements and the infrared measurement,
wherein the at least one color component cell also senses an infrared component.

8. The imaging apparatus of claim 5, wherein the infrared measurement only senses an infrared component.

9. The imaging apparatus of claim 8, wherein the image sensor further comprises a component separator to derive a color component from an arithmetic operation with one of the respective color measurements and the infrared measurement,
wherein the at least one color component cell also senses an infrared component.

10. The imaging apparatus of claim 4, wherein the image processor comprises:
an image control unit to receive the electrical signal, to image-process the electrical signal, and to output a result of the image-processing as an image signal;
an object discriminating unit to extract an object component, which is a target of interest in the image signal, from the image signal and to discriminate the extracted object component; and
a main control unit to control the image control unit, the image sensor, and/or the object discriminating unit.

11. The imaging apparatus of claim 10, wherein the object discrimination unit executes authentication to determine whether the discriminated object component is an allowed object component.

12. The imaging apparatus of claim 10, wherein the image processor further comprises:
a user manipulation unit to generate a user signal based on a manipulation of a user and to output the user signal to the main control unit;
a display unit to display a result of the discrimination by the object discriminating unit to the user; and
a light emitting unit to emit at least one of a visible light and an infrared ray to an image area, corresponding to the image, under the control of the main control unit,
wherein the main control unit controls the image control unit, the image sensor, the object discriminating unit, and the light emitting unit in response to the user signal.

13. The imaging apparatus of claim 10, wherein the image control unit comprises:
a control signal generation unit to output a first control signal, received from the main control unit, to the image sensor and second and third control signals received from the main control unit;
a white balancing processing unit to execute white balancing on the visible light component included in the electrical signal in response to the second control signal and outputting a result of the white balancing; and
a component selection unit to select, in response to the third control signal, one of the infrared component included in the electrical signal and the result of the white balancing received from the white balancing processing unit and to output a result of the selection as the image signal,
wherein the image sensor senses the image in response to the first control signal.

14. The imaging apparatus of claim 10, wherein the object discrimination unit comprises:
an object component extraction unit to extract the object component from the image signal;
a recognition unit to calculate a score of the extracted object component using templates of a pre-allowed object component; and
an authentication unit to compare the score with a predetermined critical value and authenticating whether the extracted object component matches the pre-allowed object component.

15. The imaging apparatus of claim 14, wherein the object discrimination unit further comprises:
a database storing the templates of the pre-allowed object components; and
a registration unit to register the templates of the pre-allowed object component in the database.

16. The imaging apparatus of claim 14, wherein the object component is at least one of a face and an iris.

17. The imaging apparatus of claim 14, wherein the object component extraction unit comprises:
a storage unit to store the image signal and to output the infrared component included in the stored image signal to the recognition unit;
a face extraction unit to extract a face from the stored image signal and to output the extracted face to the recognition unit; and
an eye extraction unit to extract an eye from the extracted face and to output the extracted eye to the recognition unit.

18. The imaging apparatus of claim 17, wherein the recognition unit comprises:
a face normalization unit to normalize a face image using the extracted face and the infrared component;
a face template extraction unit to extract a template of the face from the normalized face image;
a face score calculation unit to calculate a score of the extracted template for the face based on a result of a comparison of the extracted face template with the templates of the pre-allowed object component;
an iris separation unit to separate an iris image using the extracted eye and the infrared component;
an iris normalization unit to normalize the separated iris image;
an iris template extraction unit to extract a template of the iris from the normalized iris image; and
an iris score calculation unit to calculate a score of the extracted template of the iris based on a result of the a comparison of the extracted template of the iris with the templates of the pre-allowed object component.

19. An object discriminating method, comprising:
determining whether a user is to be authenticated;
optically sensing both a visible light component and an infrared component included in a light spectrum of an image and converting the sensed visible light component and infrared component into an electrical signal, based on the determination of whether the user is to be authenticated;
determining whether an object component, which is a target of interest in the image, is extracted from the electrical signal;
determining whether the extracted object component matches a pre-registered allowed object component based on the determination of whether the object component is extracted from the electrical signal;
determining that the extracted object component has an appropriate identity, based on an appropriate identity result for the determination of whether the extracted object component matches the pre-registered allowed object component;
determining that the extracted object component does not have the appropriate identity, based on not obtaining an appropriate identity result for the determination of whether the extracted object component matches the pre-registered allowed object component or based on the determination that the object component is not extracted from the electrical signal; and
outputting an indication of whether the extracted object component is the appropriate identity.

20. The image discriminating method of claim 19, wherein the determining of whether the extracted object component matches the pre-registered allowed object component comprises:
calculating a score of the extracted object component by comparing a template of the extracted object component with a pre-stored template of the object component; and
determining whether the score is greater than a critical value,
wherein when the score is determined to be greater than the critical value the object component is considered to match the pre-registered allowed object component.

21. At least one medium comprising computer readable code to implement the method of claim 19.
